(19) United States
(12) Patent Application Publication
(10) Pub. No.: US 2014/0169019 A1
(43) Pub. Date: Jun. 19, 2014

(54) VEHICULAR INTEGRATED PERSONNEL PROTECTION DEVICE

(71) Applicant: MOVE OVER, LLC, Manhattan, KS (US)

(72) Inventor: Rick Allen Fulton, Manhattan, KS (US)

(73) Assignee: MOVE OVER, LLC, Manhattan, KS (US)

(21) Appl. No.: 14/107,243

(22) Filed: Dec. 16, 2013

Related U.S. Application Data
(60) Provisional application No. 61/737,526, filed on Dec. 14, 2012.

(51) Int. Cl. B60R 21/34

(52) U.S. Cl. CPC B60R 21/34
USPC 362/516; 362/549; 362/543

(57) ABSTRACT

A vehicular integrated personnel protection device is operable to increase the visual and physical presence of a vehicle relative to approaching vehicular traffic. The device includes an erect frame and a light directing element. The light directing element is attached relative to the erect frame and is positioned along an outer margin of the frame to direct light from the erect frame, with the light being viewable by the approaching vehicular traffic. The erect frame presents an open area surrounded by the outer margin, with the erect frame and light directing element cooperatively providing a window that is operable to draw attention to the scene of the vehicle and to permit the approaching vehicular traffic to see a person ahead of the device.

This application claims the benefit of U.S. Provisional Application Ser. No. 61/737,526, filed Dec. 14, 2012, entitled VEHICULAR INTEGRATED PERSONNEL PROTECTION ARM, which is hereby incorporated in its entirety by reference herein.

### BACKGROUND

1. Field

The present invention relates generally to a vehicular integrated personnel protection device. More specifically, embodiments of the present invention concern a vehicular integrated personnel protection device that provides illumination from reflectors and/or lights along with an open frame design and/or minimal dimension. Embodiments of the device are operable to visually prompt the driver of an approaching vehicle to move over and are also operable to provide a secondary physical prompt. Embodiments of the device provide a physical prompt if the approaching vehicle hits the device. Such an impact could prompt the driver of the approaching vehicle to swerve away from the scene ahead. The illustrated device preferably provides protection by increasing awareness of a stopped vehicle and people at the scene of the stopped vehicle.

2. Discussion of Prior Art

It is known in the art to provide a vehicle with warning lights and/or a warning sign. For instance, police cruisers, ambulances, tow trucks, and other roadside assistance vehicles have long used warning light arrangements to make other drivers aware of their presence. Also, some road construction vehicles use warning lights or a warning sign with lights to emphasize their presence to oncoming traffic. Yet further, such vehicles often use lights as indicia to instruct oncoming traffic to move away from the vehicle by moving into an adjacent lane.

However, prior art warning lights and warning signs have various deficiencies. Prior art warning lights and signs primarily draw attention to the lights and signs themselves and the vehicles they are on. These prior devices may raise the perceived height of the vehicle they are on but do little if anything to enhance the perceived width. Prior devices do little if anything to directly improve the quality of the work zone adjacent to the vehicle in which the officer or other service worker might be most vulnerable.

### SUMMARY

The following brief summary is provided to indicate the nature of the subject matter disclosed herein. While certain aspects of the present invention are described below, the summary is not intended to limit the scope of the present invention.

Embodiments of the present invention provide a vehicular integrated personnel protection device that does not suffer from the problems and limitations of the prior art devices set forth above.

A first aspect of the present invention concerns a vehicular integrated personnel protection device operable to extend laterally from a vehicle to increase the visual and physical presence of the vehicle relative to approaching vehicular traffic. The device broadly includes an erect frame and a light directing element. The erect frame includes a frame section that forms a continuous outer margin of the erect frame. The light directing element is attached relative to the erect frame and is positioned along the outer margin to direct light from the erect frame, with the light being viewable by the approaching vehicular traffic. The erect frame presents an open area surrounded by the outer margin, with the erect frame and light directing element cooperatively providing a window that is operable to draw attention to the scene of the vehicle and to encourage the approaching vehicular traffic to see a person ahead of the device.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary rear perspective of a vehicle and a vehicular integrated personnel protection device mounted on the vehicle and constructed in accordance with a preferred embodiment of the present invention, with the vehicular integrated personnel protection device in an extended position and including a mount, an erect frame, an elongated rod, front and back lights, and reflectors 32, with the lights being activated;

FIG. 1A is a schematic view of the vehicular integrated personnel protection device shown in FIG. 1, showing a powered motor and lights operably connected to a vehicle battery by a controller with switches;

FIG. 2 is a fragmentary side elevation of the vehicle and vehicular integrated personnel protection device shown in FIG. 1, showing the vehicular integrated personnel protection device in the extended position where the frame projects laterally relative to a side panel of the vehicle, with the front lights being depicted as emitting beams of light forwardly and downwardly from the frame;

FIG. 3 is a fragmentary front elevation of the vehicle and vehicular integrated personnel protection device shown in FIGS. 1 and 2, showing the vehicular integrated personnel protection device extended and the front lights emitting the beams of light downwardly and inboard toward the vehicle;

FIG. 4 is a fragmentary rear elevation of the vehicle and vehicular integrated personnel protection device shown in FIGS. 1-3, showing the vehicular integrated personnel protection device extended;

FIG. 5 is a fragmentary top view of the vehicle and vehicular integrated personnel protection device shown in FIGS. 1-4, showing the vehicular integrated personnel protection device extended and the front lights emitting the beams of light forwardly and inboard toward the vehicle;

FIG. 6 is a fragmentary side elevation of the vehicle and vehicular integrated personnel protection device similar to FIG. 2, but showing the vehicular integrated personnel protection device in a retracted position and the lights as being deactivated;

FIG. 7 is a fragmentary rear elevation of the vehicle and vehicular integrated personnel protection device similar to FIG. 4, but showing the vehicular integrated personnel protection device in the retracted position and the lights as being deactivated;

FIG. 8 is a fragmentary top view of the vehicle and vehicular integrated personnel protection device similar to FIG. 5, but showing the vehicular integrated personnel protection device in the retracted position and the lights as being deactivated;

FIG. 9 is a fragmentary lower front perspective of the vehicular integrated personnel protection device shown in FIGS. 1-8, showing the mount cross-sectioned to depict a powered motor and direct current lines that provide power to the motor and to the lights, with the vehicular integrated personnel protection device being in the retracted position;

FIG. 10 is a fragmentary upper front perspective of the vehicular integrated personnel protection device shown in FIGS. 1-9;

FIG. 11 is a fragmentary lower front perspective of the vehicular integrated personnel protection device similar to FIG. 9, but showing the vehicular integrated personnel protection device in the extended position;

FIG. 12 is a fragmentary upper front perspective of the vehicular integrated personnel protection device similar to FIG. 10, but showing the vehicular integrated personnel protection device in the extended position; and

FIG. 13 is a fragmentary upper rear perspective of the vehicular integrated personnel protection device shown in FIGS. 1-12, showing the vehicular integrated personnel protection device in the extended position.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

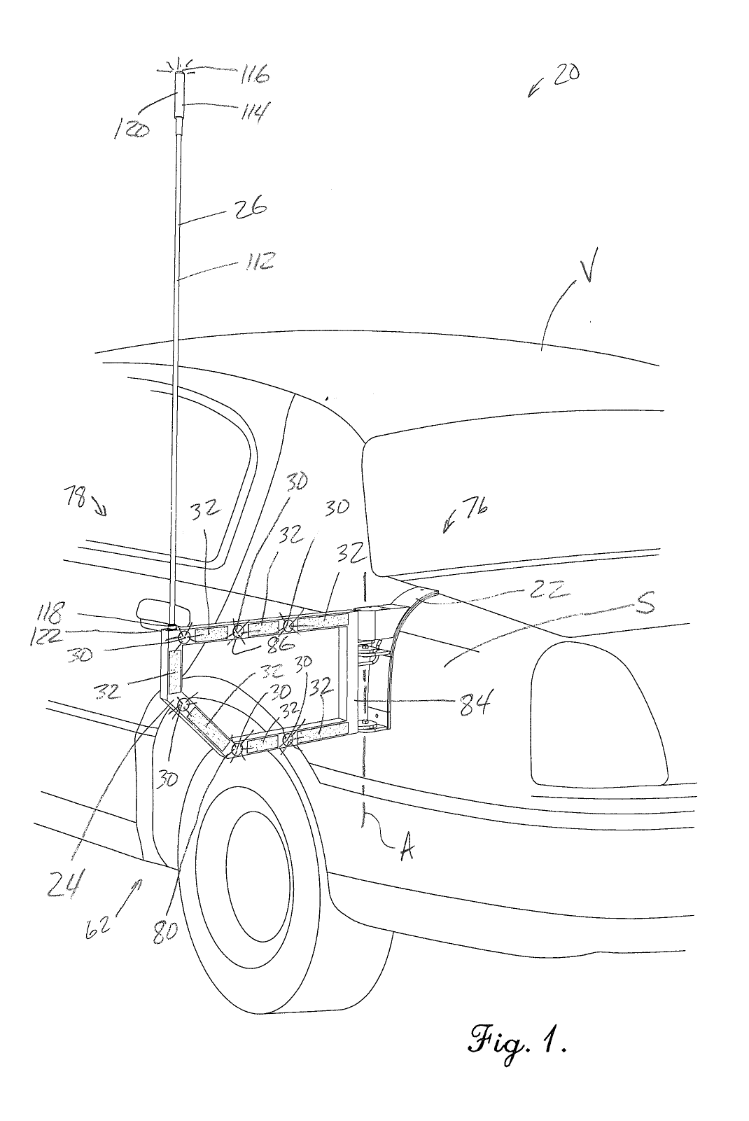

Turning initially to FIGS. 1 and 1A, a vehicular integrated personnel protection device 20 is constructed in accordance with a preferred embodiment of the present invention. The vehicular integrated personnel protection device 20 provides illumination from reflectors and/or lights along with an open frame design and/or minimal dimensions. The device 20 is operable to visually prompt the driver of an approaching vehicle (not shown) to move over and is also operable to provide a secondary physical prompt. The device 20 provides a physical prompt if the approaching vehicle hits the device 20. Such an impact could prompt the driver of the approaching vehicle to swerve away from the scene ahead. Generally, the device 20 is operable to provide visual and physical prompts with respect to approaching vehicles that approach the scene of the vehicle V from behind the vehicle V. However, it will be appreciated that the device 20 could also provide the same or similar visual and physical prompts with respect to vehicles that approach from ahead of the vehicle V. In any event, the illustrated device 20 preferably provides protection by increasing awareness of a stopped vehicle and people at the scene of the stopped vehicle. As will be discussed, the device 20 provides a window that is operable to draw attention to the scene of the vehicle V and to permit the approaching vehicular traffic to see a person ahead of the device 20.

The vehicular integrated personnel protection device 20 is preferably mounted to a vehicle V for selective use by a person, such as the vehicle operator. However, it is within the ambit of the present invention where the device 20 is used with an alternative vehicle. For instance, while the illustrated vehicle V is preferably a four-door sedan, the device 20 could be used with other automobiles, such as a truck or van. In this manner, the illustrated device 20 is configured for use with various vehicles, particularly where the vehicle operator steps into and out of the vehicle adjacent to a busy street or intersection. In one application, the device 20 could be used by a police officer as protection during various tasks. For instance, the device 20 could be activated when the officer is standing beside a stopped vehicle, is working an accident scene, or is helping a stalled motorist. Consequently, the device 20 preferably provides protection to the police officer by increasing awareness of the vehicle V, the officer, and any other people at the scene of the vehicle V. Thus, the device 20 could be used with emergency service vehicles, such as a police cruiser, an ambulance, a tow truck, or other roadside assistance vehicles. Similarly, the device 20 could be used on a privately owned vehicle that is used near busy streets or intersections, such as a utility truck or a tow truck. Again, in these and other applications of the illustrated device 20, the device 20 preferably operates as protection by increasing awareness of the vehicle V and any people at the scene of the vehicle V.

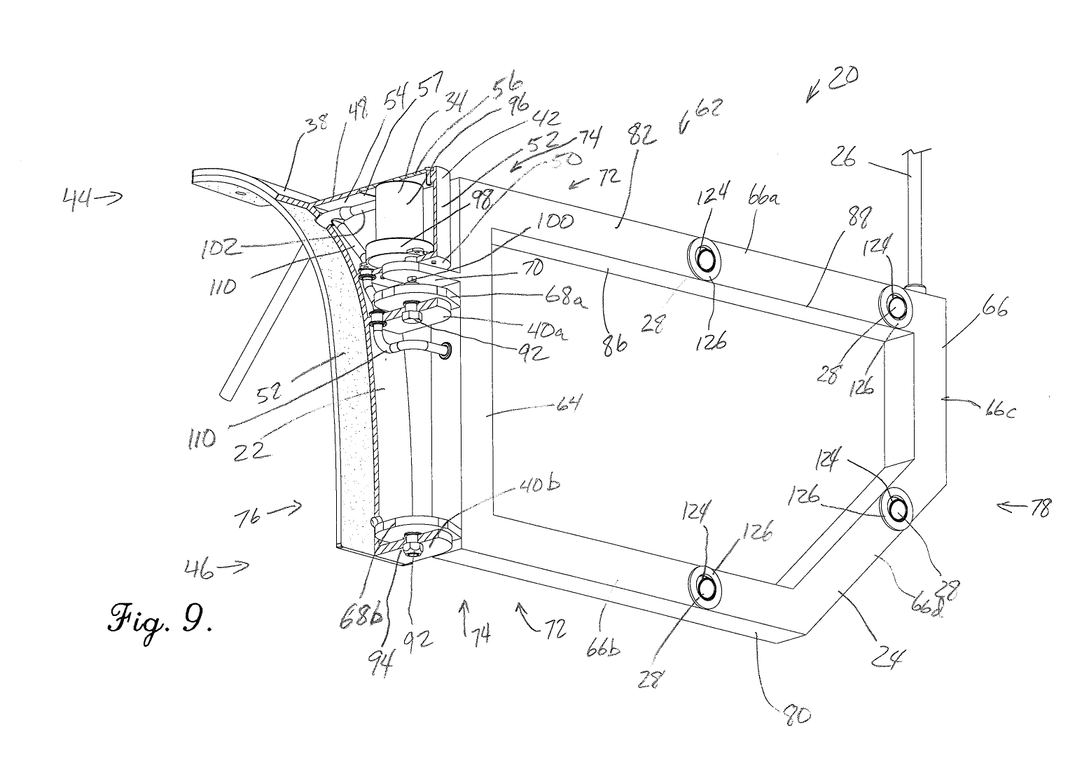

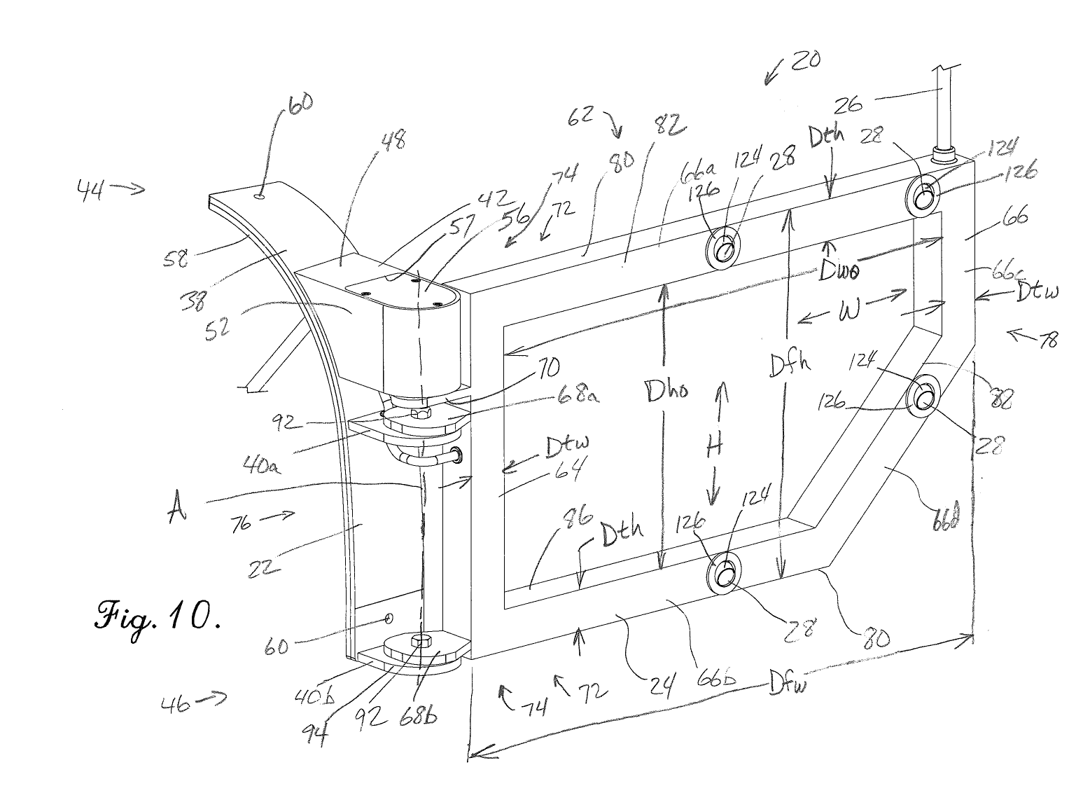

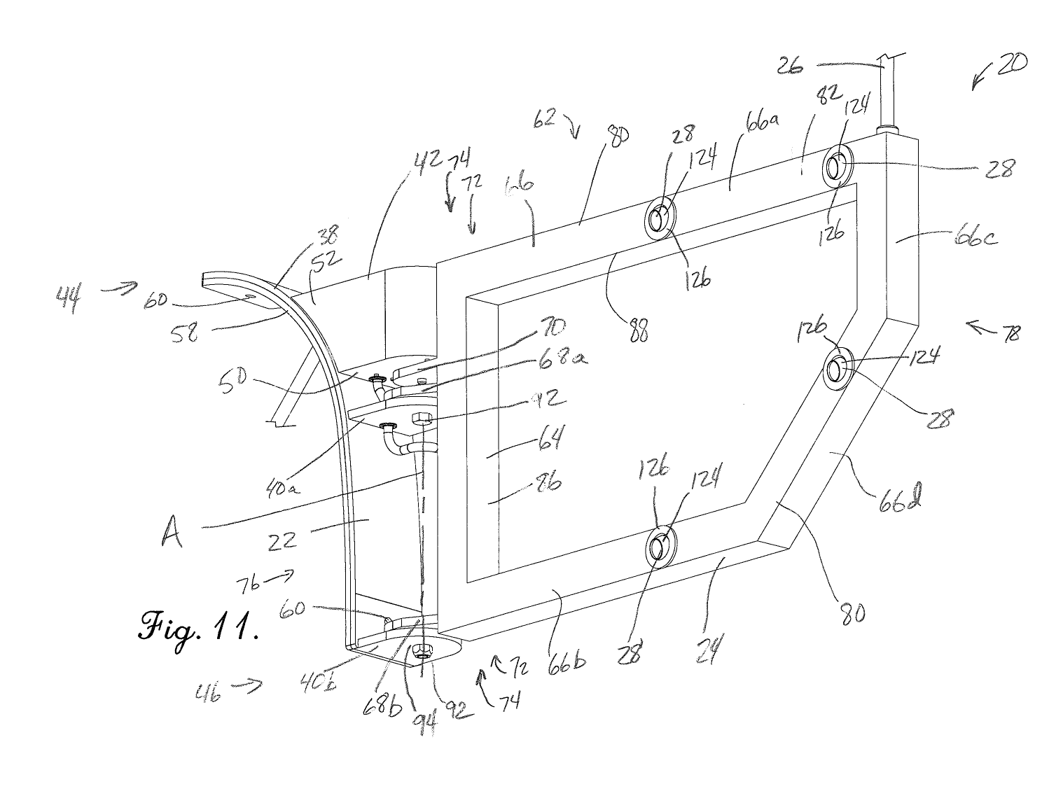

Turning to FIGS. 9-13, the mount 22 is preferably configured to support the erect frame 24 for swinging movement between an extended position (see FIGS. 11-13) and a retracted position (see FIGS. 9 and 10). The mount 22 preferably includes a curved body 38, upper and lower hinge plates 40a,b, and motor housing 42.

The curved body 38 is elongated and extends between upper and lower ends 44,46. The body 38 is preferably configured to conform to the shape of a left side panel S of the vehicle V. However, the curved body 38 could be alternatively shaped without departing from the scope of the present invention (e.g., for attachment to an alternative vehicle). While the illustrated mount 22 is attached to the left side panel S of vehicle V to allow the device to project laterally from the left side panel S, it will be appreciated that the mount 22 could be attached to the right side panel (not shown) of vehicle V. Also, the mount 22 could be configured for attachment to another part of the vehicle V.

The upper hinge plate 40a is preferably attached to the body 38 between the upper and lower ends 44,46. The lower hinge plate 40b is preferably attached to the body 38 adjacent the lower end 46. The hinge plates 40a,b preferably extend parallel to one another to receive corresponding hinge plates of the erect frame 24.

Turning to FIG. 9, the illustrated motor housing 42 includes upper and lower walls 48,50 and side wall 52 that cooperatively form a chamber 54 to receive the powered motor 34. The motor housing 42 also includes a removable lid 56 that covers an opening 57 presented by the walls 48,50,52. The motor housing 42 is attached to the body 38 between the upper hinge plate 40a and the upper end 44.

The components of the mount 22 are all preferably manufactured from aluminum plate material. However, it is within the scope of the present invention where the components include an alternative material, such as a synthetic resin material.

The mount 22 is preferably secured to the side panel S by positioning a seal 58 between the body 38 and the side panel S and by securing the body 38 and seal 58 to the side panel S with fasteners (not shown) that extend through openings 60 and through the side panel S. The seal 58 preferably includes a flat strip of synthetic rubber, although the seal 58 could include alternative materials such as an alternative elastomeric material.

Referring again to FIGS. 9-13, the erect frame 24 is preferably configured to support the elongated rod 26, lights 28,30, and reflectors 32. The erect frame 24 presents an open area surrounded by an outer margin, with the erect frame 24, lights 28,30, and reflectors 32 cooperatively providing a window 62. The erect frame 24 cooperates with the rod 26, lights 28,30, and reflectors 32 to draw attention to the scene of the vehicle V. The erect frame 24 preferably permits the approaching vehicular traffic to see a person ahead of the device 20. That is, the erect frame 24 is open so as not to impede the view of the scene of the vehicle V, particularly when the scene is viewed from the approaching vehicle. The erect frame 24 preferably includes tubular inboard and outboard frame sections 64,66, hinge plates 68a,b, and a driven tab 70.

Preferably, the outboard frame section 66 includes an upper frame element 66a, a lower frame element 66b, and end frame elements 66c,d. The outboard frame section 66 presents ends 72 that are attached to corresponding ends 74 of the inboard frame section 64. The erect frame 24 also preferably presents inboard and outboard frame ends 76,78.

The hinge plates 68a,b and driven tab 70 are preferably fixed to the inboard frame section 64. Preferably, the hinge plates 68a,b are sized and positioned for pivotal attachment to corresponding hinge plates 40a,b of the mount 22. The driven tab 70 is sized and positioned to be engaged by a motor shaft of the motor 34.

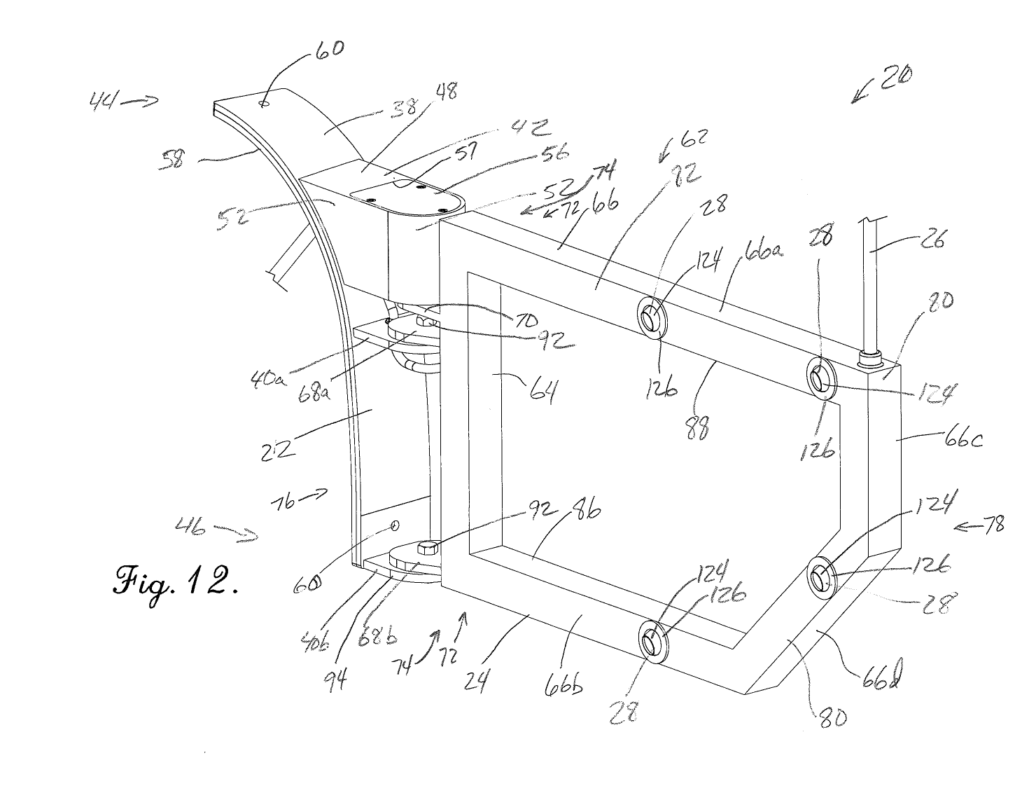

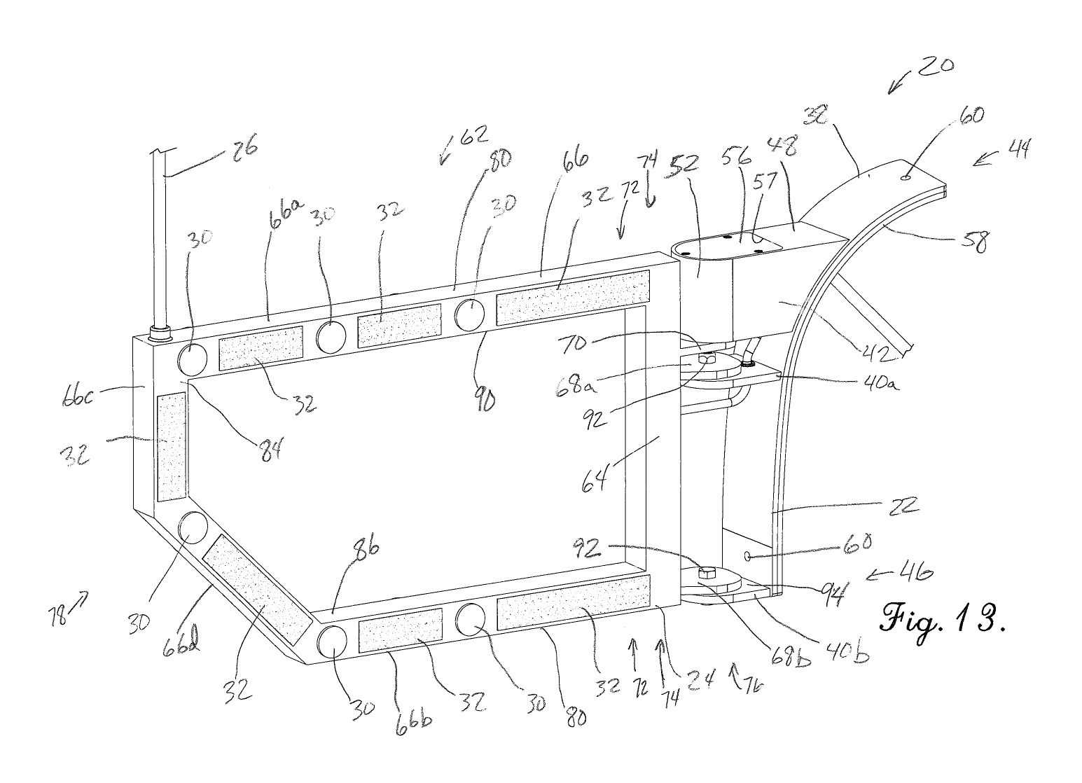

The illustrated frame sections 64,66 are attached end-to-end and cooperatively form an endless frame that presents an endless outer margin 80. The erect frame 24 also preferably presents front and back sides 82,84 and an opening 86 that extends from the front side 82 to the back side 84. Thus, the opening 86 provides the open area of the frame 24, with the area being surrounded in the illustrated embodiment by the frame 24. Due to the configuration of the illustrated opening 86, the erect frame 24 also preferably presents an open front face 88 (see FIG. 12) that extends along the front side 82 and an open back face 90 (see FIG. 13) that extends along the back side 84. Again, the erect frame 24 preferably has an open configuration so as not to impede the view of an approaching vehicle.

However, it is within the ambit of the present invention where the frame sections 64,66 of the erect frame 24 are alternatively configured. For instance, the erect frame 24 may not have an endless outer margin 80. In one alternative embodiment, the erect frame 24 could include tubular ends that are spaced apart from one another and unattached to another part of the erect frame 24. For example, the erect frame 24 could be devoid of the inboard frame section 64, with the ends of the outboard frame section 66 being attached to corresponding hinge plates 68. Similarly, the erect frame 24 could be devoid of at least one of the frame elements 66a,b,c,d.

Yet further, other alternative frame shapes and/or configurations are within the scope of the present invention. For instance, the illustrated frame 24 preferably has a unitary, rigid construction. However, the frame 24 could include components that are shiftable relative to one another. For instance, the frame 24 could include multiple frame sections that are foldable relative to one another (e.g., to allow the frame 24 to be compactly stored). However, even with such multiple shiftable frame sections, the illustrated frame 24 could still be configured to provide the window 62.

While the illustrated opening 86 of the erect frame 24 preferably provides the open area, it is within the principles of the present invention where the open area is alternatively provided. For instance, a transparent pane of synthetic resin could be attached to the erect frame 24 to span the frame 24 while providing an open area that allows approaching traffic to view the scene of the vehicle V. For some aspects of the present invention, the frame 24 and the open area could be provided solely by such a transparent pane (e.g., where the lights 28,30, hinge plates 68, and rod 26 are attached directly to the pane).

The erect frame 24 preferably presents a maximum frame width dimension Dfw and a maximum frame height dimension Dfh (see FIG. 10). The maximum frame width dimension Dfw preferably ranges from about twelve inches (12″) to about twenty-four inches (24″) and, more preferably, ranges from about eighteen inches (18″) to about twenty-four inches (24″). The maximum frame height dimension Dhw preferably ranges from about two inches (2″) to about twelve inches (12″) and, more preferably, ranges from about three inches (3″) to about ten inches (10″). However, it is within the ambit of the present invention where the erect frame 24 presents dimensions outside of these preferred height and width dimensions.

The illustrated frame sections 64,66 are preferably tubular. Furthermore, the frame sections 64,66 are each preferably formed of square aluminum tubing. In the preferred embodiment, the square tubing preferably presents a frame thickness dimension that ranges from about one-half inch (½″) to about three inches (3″) and, more preferably, ranges from about three-quarters of an inch (¾″) to about one and one-half inches (1½″).

However, the principles of the present invention are applicable where the frame sections 64,66 have an alternative tubing cross section shape and/or tubing material. For instance, the frame sections 64,66 could be made from round or oval tubing instead of square tubing. Yet further, the frame sections 64,66 could have various other tubular cross-sectional shapes (such as a rectangular shape that is elongated and presents a very narrow width). Yet further, the frame sections 64,66 could include an alternative material, such as a synthetic resin material (e.g., where the frame sections are made from urethane, fiberglass, or carbon fiber).

While the illustrated frame 24 preferably has a generally rectangular shape, the principles of the present invention are applicable where frame 24 is alternatively shaped. For instance, the frame 24 could be square, triangular, or octagonal.

The illustrated opening 86 defines a maximum opening width dimension Dwo that extends along a width spanning direction W and a maximum opening height dimension Dho that extends along a height spanning direction H (see FIG. 10). It will be appreciated that the opening 86 is preferably sized and positioned relative to the frame 24 so that the erect frame 24 provides the window 62.

The frame sections 64,66 each define a corresponding frame thickness dimension Dtw measured along the width spanning direction W (see FIG. 10). A ratio of the maximum opening width dimension Dwo to the frame thickness dimension Dtw measured along the width spanning direction W is preferably greater than about 2:1 and, more preferably, is greater than about 5:1.

The outboard frame section 66 also defines a frame thickness dimension Dth measured along the height spanning direction H (see FIG. 10). A ratio of the maximum opening height dimension Dho to the frame thickness dimension Dth measured along the height spanning direction H is preferably greater than about 2:1 and, more preferably, is greater than about 5:1.

Preferably, the illustrated frame 24 has a frame thickness dimension that is substantially constant along the peripheral length of the frame 24. However, the frame 24 could be constructed so that the frame thickness dimension various along the peripheral length of the frame 24.

Turning to FIGS. 9-13, the frame 24 is preferably pivotally attached to the mount 22. In particular, hinge plates 40a,68a are attached to one another with a fastener 92, and hinge plates 40b,68b are attached to one another with another fastener 92. Thus, the hinge plates 40,68 and fasteners 92 cooperatively provide a hinge 94 that permits swinging movement between the frame 24 and the mount 22. It will be appreciated that the hinge 94 could be alternatively configured without departing from the scope of the present invention. For instance, the illustrated hinge 94 defines an upright rotation axis A (see FIG. 1) that is generally perpendicular to a lateral axis of the frame 24 and to the adjacent ground. However, the principles of the present invention are applicable where the axis A is alternatively positioned and/or arranged (e.g., to permit convenient storage of the device 20 when the device is retracted).

Also, the frame 24 could be alternatively supported by the mount 22. In at least one alternative embodiment, the frame 24 could be alternatively shiftably supported by the mount 22 (e.g., where the frame 24 is slidably supported by the mount 22). For instance, the frame 24 could be laterally slidable into and out of a pocket presented by the vehicle V, with the frame 24 being slidable into and out of a retracted position where the frame 24 is partly or entirely positioned within the pocket. Yet further, the frame 24 could be removably attached to the mount 22 so that securement of the frame 24 into one of the extended and retracted positions is done by removably attaching the frame 24 to the mount 22.

Again, the device 20 is attached to the left side panel S of vehicle V. However, the device 20 could be attached to the right side panel (not shown) of vehicle V. Yet further, a pair of devices 20 could be attached to the vehicle V, with one device 20 attached to the left side panel S and one device 20 attached to the right side panel. When the mount 22 is attached to the vehicle V, the frame 24 preferably extends laterally from the side of the vehicle V in the extended position. Also, the frame 24 preferably extends substantially parallel to the side of the vehicle V in the retracted position. However, the frame 24 could be alternatively positioned relative to the vehicle V in the extended and/or retracted positions without departing from the scope of the present invention.

The illustrated frame 24 preferably swings through an angle of at least about ninety degrees (90°) when moving between the extended position (see FIGS. 11-13) and the retracted position (see FIGS. 9 and 10). However, it will be appreciated that the construction of hinge 94 and the attachment of the device 20 on the vehicle V permits the frame 24 to swing through an alternative angle.

While the illustrated hinge 94 preferably permits the frame 24 to be freely swung relative to the mount 22, it is within the ambit of the present invention where the interconnection between the mount 22 and frame 24 is alternatively configured. For instance, the hinge 94 could include a detent mechanism that serves to index the frame 24 into the retracted position and/or the extended position. The hinge 94 could also include stops to restrict forward swinging of the frame 24 beyond the extended position. Similarly, the hinge 94 could include stops to restrict inboard swinging of the frame beyond the retracted position.

Also, the hinge 94 could include a spring arrangement that urges the frame 24 into the retracted position and/or the extended position. For some aspects of the present invention, the mount 22 and frame 24 could have an interconnection structure that restricts swinging or other shifting movement into and/or out of the retracted and/or extended positions.

Turning to FIGS. 1A and 9, the powered motor 34 preferably comprises an electric servo motor with a cover 96, a gear reduction drive 98, and an output shaft 100 (see FIG. 9). The drive 98 preferably includes a worm gear arrangement that restricts swinging movement of the frame 24 when the motor 34 is stopped. However, it is within the scope of the present invention where the drive 98 is alternatively configured to transmit power from the motor 34. Yet further, the device 20 could be devoid of drive 98.

While the device 20 is constructed to restrict swinging of the frame 24 when the motor 34 is stopped, the principles of the present invention are applicable where the frame 24 can be swung between the extended and retracted positions when the motor 34 is stopped (e.g., when the motor 34 loses power, fails, or otherwise becomes inoperable). For instance, the device 20 could include a second hinge that permits the frame 24 to be selectively swung manually by the operator between the extended and retracted positions. Such an alternative construction could be provided to allow convenient operation of the device 20 or to allow operation of the device 20 in the event the motor 34 becomes inoperable.

The motor 34 is mounted within the housing 42 and the shaft 100 is secured to the tab 70 so that rotation of the shaft 100 causes corresponding swinging of the frame 24. The motor 34 is operably coupled to a direct current line 102 that extends through the body 38 to the controller 36 and is selectively powered by a battery 104 (see FIG. 1A). The illustrated battery 104 is preferably a battery of the vehicle V, but could be provided independently of the vehicle's systems.

While the illustrated motor arrangement is preferred, the principles of the present invention are applicable where the motor 34 is alternatively configured. For instance, instead of being an electric motor, the motor 34 could be pneumatically or hydraulically powered. Also, the motor 34 could comprise a linear motor instead of a rotating motor. Yet further, for some aspects of the present invention, the device 20 could be devoid of a motor (i.e., where the device is swung manually between the retracted and extended positions).

Again referring to FIGS. 1A and 10, the controller 36 preferably includes a switch 106 that selectively provides power from the battery 104 to the motor 34 via line 102. The controller 36 also preferably includes a switch 108 that selectively provides power from the battery 104 to the lights 28,30 via a line 110. The illustrated controller 36 is preferably installed in the vehicle V so that the switches 106,108 are within convenient reach of the driver.

While not depicted, the controller 36 could have one or more sensors (other than switches 106,108) to control operation of the device 20. For instance, the controller 36 could include a proximity sensor to automatically stop rotation of the motor 34 when the frame 24 has been swung into the extended position or the retracted position. Also, the controller 36 could include a sensor to automatically activate or deactivate the lights 28,30 when the device 20 has been swung, respectively, into or out of the extended position.

When operating the vehicle V, the driver can selectively activate the device 20 by actuating the switches 106,108 to extend the frame 24 and turn on the lights 28,30 (e.g., when the driver intends to step out of the vehicle V). Similarly, the driver can selectively deactivate the device 20 by actuating the switches 106,108 to retract the frame 24 and turn off the lights 28,30.

However, the controller 36 could be alternatively configured to selectively activate and deactivate the device 20. For instance, the controller 36 could include a single switch to control actuation of the motor 34 and lights 28,30. Also, the switches 106,108 could be automatically actuated when the driver-side front door of the vehicle V is opened. For example, the controller 36 could include a sensor to sense opening of the door and circuitry (such as a programmable microprocessor) that automatically extends the frame 24 and turns on the lights 28,30 when the sensor senses that the door has been opened. In providing such an automated device deployment control, the controller 36 could also include an override switch to allow the operator to selective engage and disengage this automatic control.

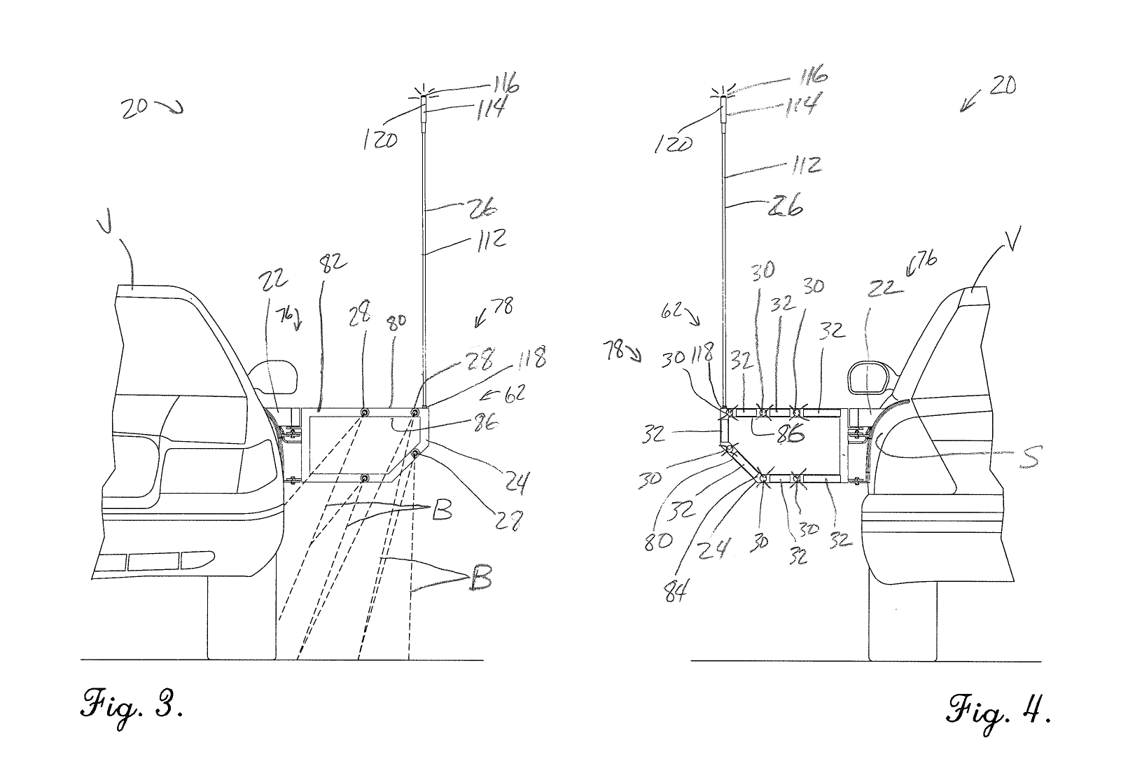

Turning to FIGS. 1-4, the rod 26 is preferably to configured to project from the frame 24 to provide a visual and physical extension of the frame 24. In particular, rod 26 extends upwardly to present a structure that can be contacted by part of an approaching vehicle that is relatively taller than a conventional car or truck. For instance, the rod 26 is sized and configured to be contacted by the mirror of an approaching semi tractor. Thus, the rod 26 can operate to provide a physical prompt to the approaching semi tractor if it drives too close to the vehicle V. The illustrated rod 26 preferably includes an elongated, flexible shaft 112, an uppermost end 114 that includes a powered light 116, and a lowermost end 118. However, the rod 26 could also be devoid of any powered light without departing from the scope of the present invention.

The shaft 112 is preferably tubular and includes a synthetic resin material. More preferably, the shaft 112 is made of fiberglass, although the shaft 112 could include other materials without departing from the scope of the present invention.

The uppermost end 114 includes a sleeve 120 and the light 116 secured to the sleeve 120. The light 116 is operably coupled to the line 110 (see FIG. 1A) by a direct current line (not shown) that extends through the shaft 112. Thus, the light 116 is also preferably turned on and off by actuating the switch 108.

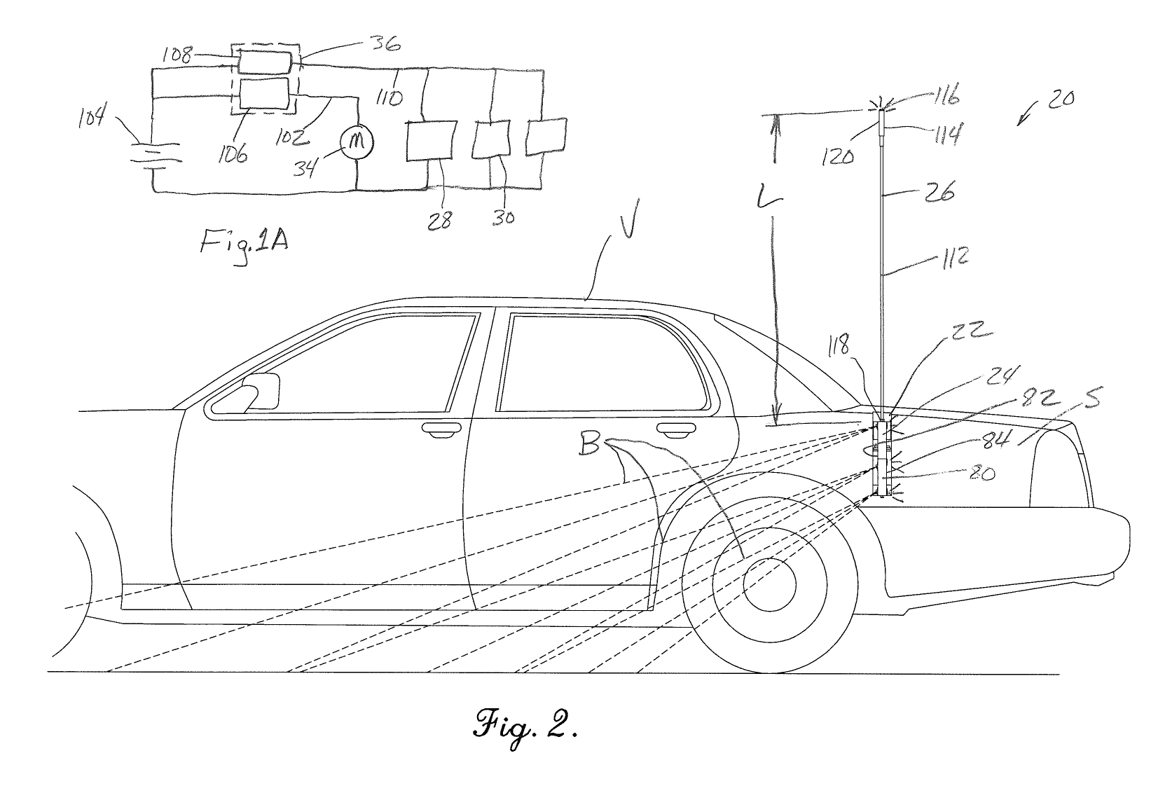

The lowermost end 118 includes a fastener 122 (see FIG. 1) that is removably secured to the frame 24. The illustrated rod 26 preferably presents a rod length L (see FIG. 2) that ranges from about one foot (1 ft) to about six feet (6 ft) and, more preferably, is about three feet (3 ft). The rod 26 preferably includes a safety rod, Model F3, manufactured by Firestik Antenna Company of Phoenix, Ariz. However, the rod 26 could be alternatively configured.

While the illustrated rod 26 preferably presents a unitary form, the rod 26 could be alternatively configured. For instance, the rod 26 could include multiple rod sections that are foldable or otherwise collapsible with one another (e.g., where the rod includes rod sections that are telescopically received by one another).

It is also within the scope of the present invention where the rod 26 extends in an alternative direction relative to the frame 24 or otherwise is alternatively positioned. For instance, when constructed to present a relatively shorter rod length L, the rod 26 could project downwardly from the frame 24. Yet further, the device 20 could include multiple rods 26 that project in different directions from the outboard end 78 of the frame 24. In such alternative configurations, it is contemplated that the rod 26 operates to provide a physical prompt to an approaching vehicle if it drives too close to the vehicle V.

Also, the principles of the present invention are applicable where the rod 26 is alternatively attached to the frame 24. For instance, the rod 26 could be pivotally attached to the frame 24 (e.g., to allow the rod 26 and frame 24 to be folded for storage). Yet further, it is within the ambit of the present invention where the device 20 does not include rod 26 or is otherwise devoid of a rod structure projecting from the frame 24.

Turning to FIGS. 9-13, the front lights 28, back lights 30, and reflectors 32 are operable to draw attention to the scene of the vehicle V while permitting the approaching vehicular traffic to see a person ahead of the device 20. When the device 20 is extended, the back lights 30, and reflectors 32 are viewable by vehicular traffic approaching from behind the vehicle V. It will also be appreciated that at least some of the light coming from the front lights 28, back lights 30, and reflectors 32 is viewable by the approaching vehicular traffic. Thus, the front lights 28, back lights 30, and reflectors 32 provide protection by increasing awareness of the vehicle V and people at the scene of the vehicle V, particularly for approaching vehicular traffic.

The front lights 28 are preferably conventional white lights attached to the outboard frame section 66. In particular, the front lights 28 each include a light bulb contained in a housing 124 that is rotatably mounted in corresponding sockets 126 fixed to the front side 82. Thus, the front lights 28 generally face forwardly to emit light forwardly when the frame 24 is swung into the extended position.

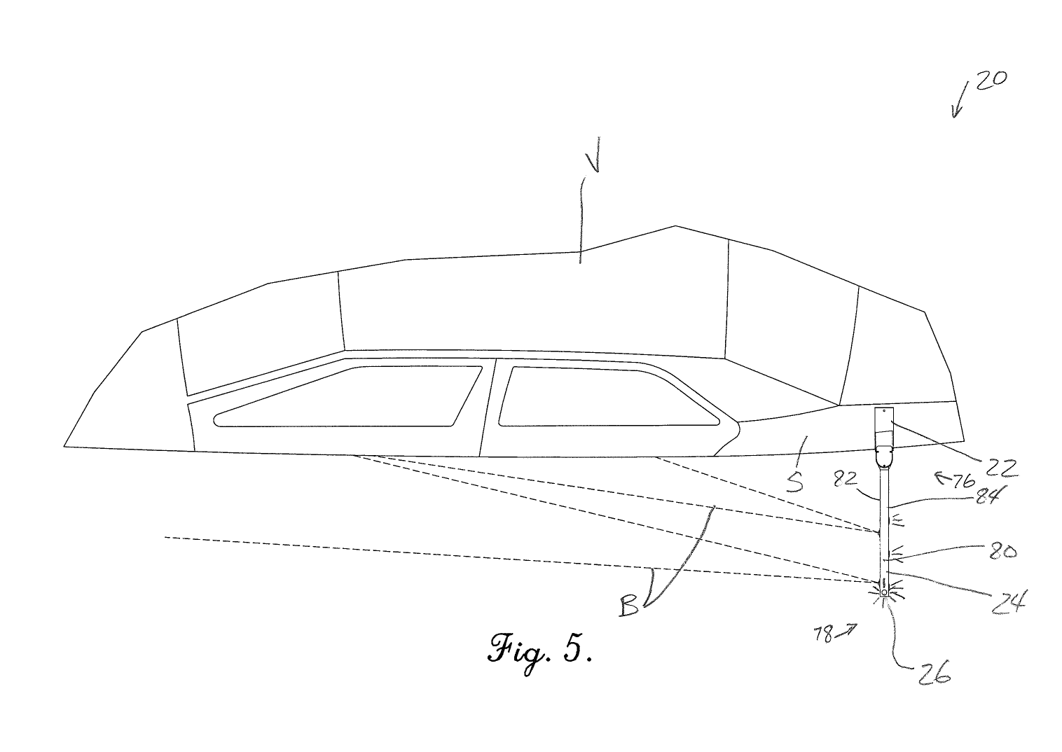

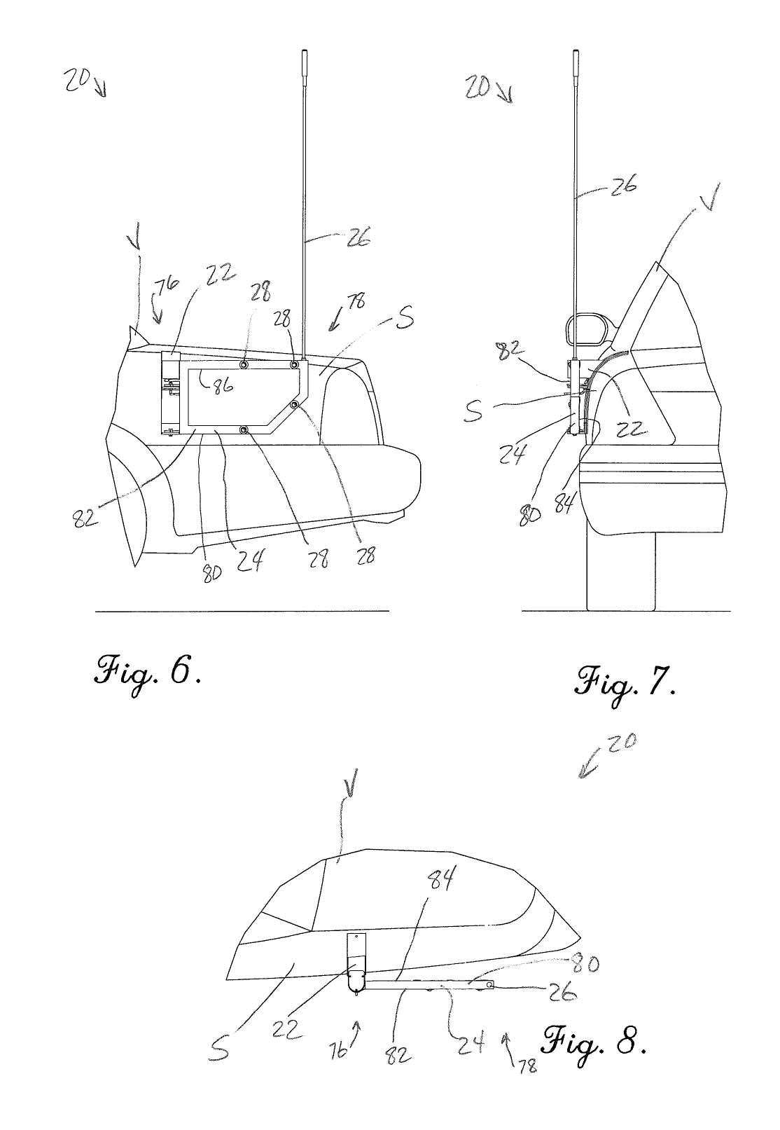

The illustrated front lights 28 are preferably positioned so that corresponding beams B are directed both forwardly and downwardly (see FIGS. 2, 3, and 5). The front lights 28 are preferably directed so that beams B project generally below a maximum height that ranges from about three feet (3 ft) to about four feet (4 ft). However, the beams B could be alternatively configured.

Furthermore, the front lights 28 are preferably positioned so that the beams B are directed laterally inboard toward the side of the vehicle V. In this manner, the beams B serve to illuminate the side of the vehicle V and the area alongside the vehicle V. Again, while the illustrated lights 28 are depicted as illuminating the left side of vehicle V and the adjacent area, the lights 28 could be alternatively directed and/or positioned.

Furthermore, each of the front lights 28 can preferably be adjustably swiveled within the sockets 126 to adjust the direction of the corresponding beams B. However, it is within the ambit of the present invention where the front lights 28 are alternatively configured. For instance, the front lights 28 could be fixed to the frame 24. The front lights 28 are operably coupled to the direct current line 110 (see FIG. 1A) that extends through the frame 24 to the controller 36.

The back lights 30 are preferably conventional colored lights secured to the outboard frame section 66. The back lights 30 preferably emit light in a broader pattern than front lights 28. That is, the front lights 28 preferably emit light in a more focused beam than the back lights 30. Also, the back lights 30 preferably emit a light beam with less intensity than the front lights. However, it is within the scope of the present invention where the lights 28,30 have alternative beam intensities, beam patterns, and/or colors. Furthermore, the back lights 30 could be programmed or otherwise controlled (e.g., using a programmable microprocessor) to emit a flashing pattern of light. For instance, the back lights could be programmed to flash in a sequence that depicts or suggests an arrow pointing away from the vehicle or a pattern similar to a sequenced turn signal to enhance the intended message to approaching traffic of the need to move over.

The back lights 30 are each fixed to the frame 24 along the back side 84 thereof and generally face rearwardly to emit light rearwardly when the frame 24 is swung into the extended position. However, the back lights 30 could be alternatively mounted without departing from the scope of the present invention. The back lights 30 are operably coupled to the direct current line 110 (see FIG. 1A) that extends through the frame 24 to the controller 36.

The reflectors 32 each preferably include reflector tape with an adhesive backing (not shown). The reflector tape is adhered to the frame 24 along the back side 84 thereof along locations adjacent to the back lights 30. The principles of the present invention are applicable where the reflectors 32 are alternatively configured to provide a light reflecting surface. Furthermore, the reflectors 32 could be alternatively positioned along the frame 24 (e.g., where reflectors 32 are attached along the front and back sides 82,84 of the frame 24).

The device 20 preferably includes the illustrated combination of lights 28,30,116 and reflectors 32. However, the device 20 could include an alternative arrangement of lights and/or reflectors. Furthermore, the device 20 could include only lights or could include only reflectors.

It is also within the ambit of the present invention where the device 20 includes other types of light directing elements. As used herein, a light directing element broadly includes, but is not limited to, light-emitting devices, such as light bulbs, LEDs, fiber optic lights, etc. A light directing element as used herein also includes, but is not limited to, devices that transmit, focus, reflect, and/or otherwise direct light from a light source, such as an optical fiber, a reflector, or an optical lens.

In operation, the device 20 is selectively shiftable between the retracted and extended positions. At the same time, the lights 28,30,116 can be selectively activated or deactivated. For instance, when the vehicle operator is ready to exit the vehicle V, the operator can selectively move the device 20 from the retracted position to the extended position by actuating the switch 106. At the same time, before, or during the time when the device 20 is being extended, the operator can selectively activate the lights 28,30,116 by actuating the switch 108. In this manner, the device 20 provides illumination from lights 28,30,116 and reflectors 32 and serves to illuminate the scene of the vehicle V.

Again, when extended, the device 20 is operable to visually prompt the driver of an approaching vehicle (e.g., a vehicle approaching from behind the vehicle V) to move over and is also operable to provide a secondary physical prompt. The device 20 provides the physical prompt if the approaching vehicle hits the device 20. Thus, the illustrated device 20 preferably provides protection by increasing awareness of the vehicle V and people at the scene of the vehicle V.

When the vehicle operator has returned to the vehicle V, the operator can selectively move the device 20 from the extended position to the retracted position by actuating the switch 106. At the same time, before, or during the time when the device 20 is being retracted, the operator can selectively deactivate the lights 28,30 by actuating the switch 108.

Although the above description presents features of an illustrated embodiment of the present invention and alternative embodiments, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A vehicular integrated personnel protection device operable to extend laterally from a vehicle to increase the visual and physical presence of the vehicle relative to approaching vehicular traffic, said device comprising:
an erect frame including a frame section that forms a continuous outer margin of the erect frame; and
a light directing element attached relative to the erect frame and positioned along the outer margin to direct light from the erect frame, with the light being viewable by the approaching vehicular traffic,
said erect frame presenting an open area surrounded by the outer margin, with the erect frame and light directing element cooperatively providing a window that is operable to draw attention to the scene of the vehicle and to encourage the approaching vehicular traffic to see a person ahead of the device.

2. The vehicular integrated personnel protection device as claimed in claim 1,
said frame section defining an outboard end of the erect frame.

3. The vehicular integrated personnel protection device as claimed in claim 2,
said erect frame including a plurality of frame sections that include the first-mentioned frame section, with the frame sections being fixed end-to-end.

4. The vehicular integrated personnel protection device as claimed in claim 3,
said frame sections being configured so that the erect frame extends endlessly about the see-through area.

5. The vehicular integrated personnel protection device as claimed in claim 2,
said frame section defining a frame thickness dimension that is substantially constant along the length of the frame section.

6. The vehicular integrated personnel protection device as claimed in claim 1,
said see-through area defining an area spanning dimension along a spanning direction,
said erect frame defining a frame thickness dimension along the spanning direction, with a ratio of the area spanning dimension to the frame thickness dimension being greater than 2:1.

7. The vehicular integrated personnel protection device as claimed in claim 1,
said see-through area being transparent.

8. The vehicular integrated personnel protection device as claimed in claim 7,
said erect frame presenting an opening that provides the see-through area, with the erect frame extending endlessly about the opening.

9. The vehicular integrated personnel protection device as claimed in claim 1,
said erect frame presenting opposite front and back sides operable to respectively face forwardly and rearwardly when the erect frame is supported on the structure; and
a plurality of light directing elements, at least some of said light directing elements being attached to the erect frame along the back side to direct light rearwardly.

10. The vehicular integrated personnel protection device as claimed in claim 9,
some of said light directing elements being attached to the erect frame along the front side to direct light forwardly.

11. The vehicular integrated personnel protection device as claimed in claim 9,
said light directing elements being selected from the group consisting of powered lights, reflectors, and combinations thereof.

12. The vehicular integrated personnel protection device as claimed in claim 1; and
a frame mount operable to be attached to the structure,
said erect frame and said frame mount being shiftably attached to one another, with the erect frame being shiftable relative to the frame mount between a retracted position and an extended position where the erect frame is operable to expand the physical presence of the structure.

13. The vehicular integrated personnel protection device as claimed in claim 12,
said erect frame and said frame mount being pivotally attached to one another, with the erect frame being pivotal between the retracted position and the extended position.

14. The vehicular integrated personnel protection device as claimed in claim 12; and
a powered motor operably coupled with the erect frame to shift the erect frame between the retracted position and the extended position.

15. The vehicular integrated personnel protection device as claimed in claim 1; and
an extended rod,
said erect frame presenting a length that extends between inboard and outboard ends, with the inboard end operable to be shiftably attached relative to the structure,
said extended rod attached to the erect frame adjacent the outer end and extending transversely relative to the length of the erect frame.

16. The vehicular integrated personnel protection device as claimed in claim 15,
said extended rod projecting upwardly from the erect frame.

17. The vehicular integrated personnel protection device as claimed in claim 15,
said extended rod being relatively more flexible than the erect frame.
